(19) United States
(12) Patent Application Publication
(10) Pub. No.: US 2007/0243407 A1
(43) Pub. Date: Oct. 18, 2007

(54) Machinable Metallic Composites

(75) Inventors: Francis Delannay, Louvain-la-Neuve (BE); Sophie Ryelandt, Court-St-Etienne (BE)

Correspondence Address: BACON & THOMAS, PLLC, 625 SLATERS LANE, FOURTH FLOOR, ALEXANDRIA, VA, 22314, US

(73) Assignee: Universite catholique de Louvain, Louvain-la-Neuve (BE)

(21) Appl. No.: 11/660,654

(22) PCT Filed: Aug. 19, 2005
(86) PCT No.: PCT/EP05/09004

§ 371 Date: Feb. 21, 2007

(30) Foreign Application Priority Data
Aug. 21, 2004 (GB) 0418736.5

(51) Int. Cl. B32B 15/01

(52) U.S. Cl. 428/650

(57) ABSTRACT

Composites consisting of aluminum or an aluminum alloy reinforced with Invar or stainless Invar have anisotropic coefficients of thermal expansion and also anisotropic thermal conductivities. They can be used as heat sinks for electronic devices.

This invention concerns machinable metallic composites, for example but not limited to use as heat sinks for electronics devices.

The thermal management of electronic devices is a considerable problem, particularly as developments in electronic devices has lead to reductions in the physical sizes of the devices, combined with increases in the electrical energy they consume. This combination of factors results in increasing amounts of thermal energy being released by semiconductor devices in increasingly miniaturized electronic circuitry.

In order to guarantee the performance of such circuitry, the thermal energy which is generated when it is used has to be removed. The management of heat dissipation in such circumstances can therefore become a critical issue.

Most electronic power devices are mounted on base plates which act as heat sinks or heat spreaders which conduct heat away from the devices. However, this requires these plates to have both high thermal conductivity and a coefficient of thermal expansion which matches the coefficient of thermal expansion of the semiconductor materials, typically silicon and gallium arsenide, as well as that of certain packaging ceramics, for example alumina and aluminum nitride. These materials exhibit coefficients of thermal expansion in the range of from 4 to 7×10⁻⁶/K at room temperature.

Base plates for electronics devices commonly use low coefficient of expansion materials such as the Ni—Fe alloy KOVAR, or Cu—W or Cu—Mo composites. The main problem with these materials is, however, that they have high densities, which is a disadvantage in aerospace and portable applications. In addition, KOVAR, for example, has quite a low thermal conductivity (17 W/m/K).

Materials such as aluminum or copper alloys which exhibit high thermal conductivities are also used for producing heat sinks. However, their coefficients of thermal expansion of 23×10⁻⁶/K for aluminum and 17×10⁻⁶/K, respectively, at room temperature are too high in comparison with the coefficients of thermal expansion of semiconductors and substrate ceramics.

In order to reduce the thermal stresses that would develop at the interfaces between heat sinks made of these materials and electronic parts with which they are used, resulting from the coefficient of thermal conductivity mismatch, organic-based bonding layers can be inserted between the two materials. However, these layers generally have poor thermal conductivity, and so other solutions are required to this thermal management problem.

It has been proposed hitherto to overcome these problems using metal matrix composites. JP2001284508, JP2001284509, JP200169267, WO2002077303, WO2002077304, EP504532, EP1000915, and EP1055641 describe isotropic aluminum metal matrices reinforced with silicon carbide particulates for use in electronics packaging applications.

Another proposal made in JP2002356731 is to use molybdenum or tungsten particles instead of silicon carbide.

Aluminum-silicon carbide composites combine good thermal properties with low density. However, the volume fraction of silicon carbide needed to obtain a coefficient of thermal expansion lower than 12×10⁻⁶/K is greater than 60%, which makes the composites very hard and difficult to machine.

The thermal conductivity is generally lower when the reinforcement consists of metallic particulates, and the density is usually higher.

Isotropic copper metal matrix composites reinforced with FeNi Invar particles have also been proposed in JP03111524. These composites have a high density.

EP1160860 and EP1168438 propose reinforcing copper or silver matrices with low coefficient of thermal expansion particulates or with short fibers, such as those made of graphite.

In addition to the above, anisotropic composites have been proposed in which short oriented fibers are used to increase the transverse thermal conductivity of the composites (U.S. Pat. No. 4,256,792 and EP1320455), or to decrease their in-plane coefficient of thermal expansion (JP01083634).

Anisotropic metal/metal composites have been proposed in GB2074373 and FR8115361, low coefficient of thermal expansion plates made from Invar (FeNi37) being combined with copper plates which have good thermal conductivity. If the Invar reinforcing plates have through holes, better thermal conduction can be achieved through the composites. GB2074373 describes composites consisting of copper wires reinforced with Invar tubes or plates, these being produced by isostatic compression followed by hydrostatic extrusion.

All of these structures have high densities due to their copper contents. Furthermore, their thermal conductivities are quite low when the Invar reinforcement is placed in the plane of the plates.

According to the present invention there are provided composites comprising aluminum or an aluminum alloy reinforced with Invar or Stainless Invar.

By the term “Stainless Invar” we mean alloys having the following compositions:
Co: 51-58 wt %;
Fe: 34-39 wt %;
Cr: 8-10 wt %; and
C: 0.03-0.1 wt %.

Composites in accordance with the present invention have exhibited low densities of less than 4 g/cm³, high transverse thermal conductivities (κ) of greater than 190 W/m/K, isotropic in-plane coefficients of thermal expansion (α) of 5-10×10⁻⁶/K between −40 and 150° C. They have also shown good machinability with conventional tools and weldability to aluminum packages.

Composites in accordance with the present invention are preferably in the form of aluminum or aluminum alloys reinforced with a periodic structure made of sheets, plates or hollow tubes of Invar or Stainless Invar. The sheets, plates or hollow tubes can have a variety of shapes and sizes, in general with the planes of the sheets or plates substantially parallel to each other. This serves to provide the resulting composites with anisotropic coefficients of thermal expansion and also anisotropic thermal conductivities. In use as heat sinks, the Invar or stainless Invar sheets, plates or hollow tubes constituting the reinforcing structure will generally be oriented substantially perpendicular to the electronic devices to which they are attached.

Preferred reinforcing periodic structures for composites in accordance with the present invention are in the form of honeycombs or similar to honeycombs with aluminum or an aluminum alloy in the honeycombs. These composites exhibit anisotropic properties which can be used to advantage in the plane of base plates for electronic devices.

Particularly preferred composite structures in accordance with the present invention consist of a matrix of a low yield strength aluminum, for example Al 1199, with 20 wt % of Invar or Stainless Invar forming the walls of the reinforcing structure, the cells of this structure having a substantially regular hexagonal symmetry and a structural factor (cell height divided by maximum cell cross-sectional dimension (H/D)) typically between 1.0 and 0.4. Such composites when used to form heat sinks have shown low in-plane coefficients of thermal expansion combined with high transverse thermal conductivities, the reinforcing structures compensating for the mismatch in coefficients of thermal expansion for aluminum (23×10⁻⁶/K) and for Invar or stainless Invar (2×10⁻⁶/K).

The sheets, plates or tube walls are preferably from 50 to 500 μm thick, depending on the required volume fraction of the reinforcement and the required thickness of the heat sink plate to be produced, the latter determining the cell dimensions through the structural factor H/D.

The in-plane dimensions of the reinforcing structure can then be selected according to the desired structural factor and the dimensions of the final heat sink plate. They should also allow subsequent infiltration of the structure by the aluminum or aluminum alloy.

Composites in accordance with the present invention can be produced by first forming a framework from sheets, plates or hollow tubes of Invar or stainless Invar, followed by assembling, for example by welding or brazing, and then infiltrating the framework with aluminum or an aluminum alloy.

The resulting composite materials can then be cut and machined into finished products, for example heat sink plates.

The Invar or stainless Invar is preferably first formed into sheets or plates by hot rolling at CFC temperature (i.e. 1200° C) followed by cold rolling, or into tubes by extrusion or by swaging. It is finally annealed in the CFC domain, preferably in a neutral or reducing atmosphere.

Before infiltration, the Invar or stainless Invar structure should in general be annealed in the CFC range, preferably in a neutral or reducing atmosphere, and if necessary cleaned, for example with acid.

Reinforcing periodic structures for composites in accordance with the invention can also be made by powder metallurgy.

Infiltration of the structure can then be effected using molten aluminum or a molten aluminum alloy, for example using the so-called squeeze casting method.

Squeeze casting is preferably effected by first placing the reinforcing structure to be infiltrated into a mold and then heating the structure and the mold to a temperature of from 200 to 400° C. Liquid metal at a temperature of about 200° C. above its melting point (i.e. 850° C. for Al 99.99) is then cast into the mold, and pressure, for example about 25 MPa, is applied for a short time, for example up to 1 minute, to the cast metal to bring about infiltration and reinforcement of the structure. The casting can then be withdrawn from the mold and quenched in water.

The casting can then be machined to produce a heat sink of the desired dimensions after which it can be welded to an aluminum package to produce an hermetically sealed electronic device.

Cutting of the casting to the desired thickness H can be effected using conventional tools because the materials forming the composite are readily machinable. However, this can be avoided by forming a casting of the desired dimensions.

1. Composites comprising aluminum or an aluminum alloy reinforced with Invar or stainless Invar.

2. Composites according to claim 1, wherein the Invar or stainless Invar is in the form of sheets, plates or tubes.

3. Composites according to claim 1, wherein the Invar or stainless Invar is in the form of a periodic structure.

4. Composites according to claim 3, wherein the periodic structure has been produced by welding or brazing.

5. Composites according to claim 1, wherein the Invar or stainless Invar is in the form of sheets, plates or tubes which are substantially parallel to each other.

6. Composites according to claim 5, wherein the sheets are from 50 to 500 μm thick.

7. Composites according to claim 1, wherein the Invar or stainless Invar is in the form of a honeycomb or a periodic structure similar to a honeycomb.

8. Composites according to claim 7, wherein the honeycomb has a structural factor of from 1.0 to 0.4.

9. Composites according to claim 1 in the form of a heat sink.

10. Electronic devices including a heat sink formed from a composite in accordance with claim 1.

11. Composites according to claim 2, wherein the Invar or stainless Invar is in the form of a periodic structure.

12. Composites according to claim 2, wherein the Invar or stainless Invar is in the form of sheets, plates or tubes which are substantially parallel to each other.

13. Composites according to claim 2, wherein the Invar or stainless Invar is in the form of a honeycomb or a periodic structure similar to a honeycomb.
